(19) United States
(12) Patent Application Publication
(10) Pub. No.: US 2005/0018773 A1
(43) Pub. Date: Jan. 27, 2005

(54) Bit plane compression method

(76) Inventor: Renatus Josephus Van Der Vleuten, Eindhoven (NL)

Correspondence Address: U S Corporation;Intellectual Prepoerty Department, PO Box 3001, Briarcliff Manor, NY, 10510, US

(21) Appl. No.: 10/495,944

(22) PCT Filed: Oct. 25, 2002
(86) PCT No.: PCT/IB02/04480

(30) Foreign Application Priority Data
Nov. 21, 2001 (EP) 01204442.6

(51) Int. Cl. H04N 7/12

(52) U.S. Cl. 375/240.18; 375/240.12

(57) ABSTRACT

Both the frequency weighting and region of interest enhancement in MEPG4-FGS are implemented by shifting in a number of zeros in the least significant bits of selected discrete cosine transform (DCT) coefficients, by application of a weighting matrix. This effectively shifts these coefficients up a few bit planes, thereby causing their bits to appear earlier in the enhancement layer bit stream than would otherwise be the case. Thus they are given priority over coefficients that have not been shifted or have been shifted by a smaller amount in the event that the bit stream is cut. To propose herein to modify the enhancement layer bits stream of the MEPG4-FGS standard so that zeros that are shifted in are no longer encoded, thereby increasing the compression efficiency when either no or only a small number of bits is cut off from the enhancement layer.

This invention relates to an improved bit plane compression method and to an apparatus for achieving the same.

It is currently common practice for a data file containing moving pictures to be stored and transmitted in a compressed form in order to reduce the amount of storage or transmission capacity required. To allow for transmission of the moving image a small transfer rate for the pictures is beneficial so that less capacity on a communication channel is needed for a given set of moving images.

It is common to use a discrete cosine transform (DCT) to code the moving pictures, in which a given picture is typically coded in an eight pixel by eight pixel block. The DCT transform transforms the eight by eight pixel block from a spacial domain to a frequency domain. The DCT coefficients are organised in bit planes, for example 11 bit planes, because DCT coefficients are typically coded with 11 bits. The first bit plane of a block of eight by eight pixels represents the plane with all the most significant bits of each coefficient of this block. Thus, the last bit plane is constituted with all the least significant bits (LSBs) of each of the 64 coefficients (8×8) of a particular block.

Bit rate scalability is enabled by encoding the DCT coefficients bit plane by bit plane, starting at the most significant plane of each block. The goal of scalable compression methods is to generate a bit stream that can be truncated at any desired point, while always giving the best possible quality for a selected bit rate. Therefore, since a truncatable bit stream is generated, the main goal is to put the most significant information in the beginning of the bit stream.

Since each time one bit plane of a block is put in a bit stream (each block is scanned or processed eleven times, given that there are eleven DCT coefficients), there are different ways to organise the bit stream consisting of the remaining data in order to reconstruct the image. The remaining blocks can be processed in order of the importance to the human visual system. Examples will be given below.

The Moving Pictures Expert Group (MPEG) have defined a standard known as MPEG4, which standard has a Fine Granular Scalability (FGS) amendment(ISO/IEC 14496-2/AMD 4; document ISO/IEC JTC1/SC29/WG11 N3315). The MPEG4-FGS amendment produces a bit stream consisting of a non-scalable base layer (i.e. a layer which cannot be prematurely truncated in order to reduce the amount of information transmitted) and a FGS enhancement layer. This FGS enhancement layer may be cut off in order to reduce the bit rate of a data stream. To improve the video quality in the event that the enhancement layer is prematurely truncated, frequency weighting can be used to emphasise the quality of certain DCT coefficients. Frequency weighting may involve coefficient values being multiplied by one or more constants that are powers of two (e.g. 2, 4, 8, 16, etc). If a coefficient is multiplied by 4, then the least significant two bits of its binary representation will be zero; this can be termed “shifting in” two zeros. These zero bits do not necessarily only occur in the LSB plane, but can occur in multiple low-significance bit planes. MPEG4-FGS, frequency weighting and selective region of interest enhancement are discussed in “Overview of FGS scalability in MPEG4 Video Standard” by Weiping Li, in IEEE Transactions on Circuits and Systems for Video Technology Vol 11, No 3, March 2001. That document is incorporated herein by reference in order to provide background information and information relating to the advantages concerning the use of frequency weighting, selective enhancement and the MPEG4 standard referred to above.

Also, the above document refers to selective region of interest enhancement, which is also used herein and results in zeros being shifted in.

The MPEG4-FGS standard does not code original image data, but differential data (i.e. the difference between the original image data and the image data contained in the basic layer).

Disadvantages arise with the MPEG4-FGS amendment because zero value bits in the bit stream coding the images are shifted in, leading to zeros in potentially multiple low-significance bit planes. These reduce the efficiency of the enhancement layer in the event that the enhancement layer is not cut, or prematurely truncated, because the zero-bits are encoded in the bit stream.

It is an object of the present invention to address the above mentioned disadvantage. Furthermore, it is an object of the present invention to provide a method of bit plane compression having increased efficiency over the MPEG4-FGS standard.

According to a first aspect of the present invention a method of coding images in a scalable bit stream comprises transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

The invention advantageously reduces the number of bits coded, or transmitted, where an image is coded for transmission, thereby reducing system requirements. The method is particularly advantageous in a situation where little or none of the scalable bit stream component is truncated.

Preferably, only those bit values of the binary representation up to, but not including, zero bit values introduced as a result of weighting are coded.

Preferably, the weighting is a frequency weighting, and/or a selective region of interest enhancement.

Preferably, the method is a modified version of the MPEG4-FGS method.

The scalable bit stream may be coded into a non-scalable bit stream component, or base layer, and a scalable bit stream component, or enhancement layer.

Preferably, variable length coding for the RUN, EOP coding is re-optimised to account for non-encoding of the zero bits.

The coefficients are preferably discrete cosine transform coefficients, resulting from transformation of a pixel block into a frequency domain. A pixel block is preferably formed from a differential image, i.e. the difference between an original image and image data contained in a base layer. The difference between images, or difference signal, may be computed after the transform step.

According to a second aspect of the invention a method of decoding images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded, the method comprising reintroducing zeros resulting from the weighting into the coded RUN, EOP coefficients; RUN, EOP decoding; inverse weighting the coefficients; and transforming back from a frequency domain.

According to a third aspect coding apparatus comprises coding means operable to code images by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

The apparatus may also include transmission means.

The apparatus may also include viewing means.

According to a fourth aspect of the invention transmission apparatus incorporates coding apparatus of the previous aspect.

According to a fifth aspect of the invention decoding apparatus comprises decoding means operable to decode images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

The decoding apparatus may include viewing means.

The invention extends to a signal coding images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded, and to a storage medium carrying said signal.

The invention also extends to an image reproduction device comprising the decoding apparatus of the fifth aspect.

All of the features disclosed herein may be combined with any of the above aspects, in any combination.

A specific embodiment of the present invention will now be described, by way of example, and with reference to the accompanying drawings, in which:

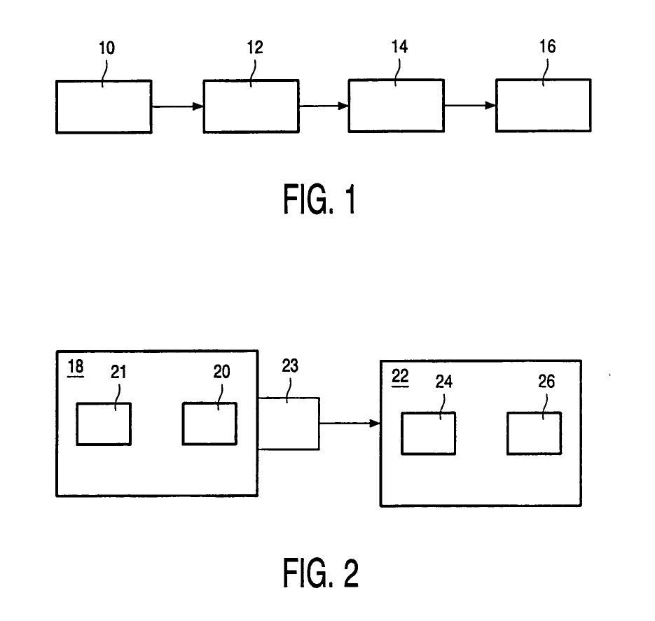

FIG. 1 is flow chart showing the compression method of the present invention; and

FIG. 2 is a schematic diagram showing coding and decoding apparatus.

As mentioned above, it has been shown that frequency weighting of DCT coefficients can considerably improve the quality of a decoded image. In addition to frequency weighting, the quality of a selected region of interest (ROI) can be improved.

Both the frequency weighting and ROI enhancement in MPEG4-FGS are implemented by shifting in a number of zeros in the least significant bits (LSBs) of selected DCT coefficients, by application of a weighting matrix to apply more weight to chosen coefficients. This effectively shifts these coefficients up a few bit planes, thereby causing their bits to appear earlier in the enhancement layer bit stream than would otherwise be the case. Thus, they are given priority over coefficients that have not been shifted or have been shifted by a smaller amount in the event that the bit stream is cut.

It is proposed herein to modify the enhancement layer bit stream of the MPEG4-FGS standard so that zeros that are shifted in are no longer encoded, thereby increasing the compression efficiency when either no or only a small number of bits is cut off from the enhancement layer.

MPEG4-FGS uses a technique known as (RUN, EOP). Where a RUN symbol represents a RUN of zero bits, i.e. the number of zeros before the next one bit. The EOP symbol encodes the End Of Plane and has the value zero when an additional (RUN, EOP) symbol follows and has the value 1 for the last (RUN, EOP) symbol.

The (RUN, EOP) technique orders the DCT block coefficient bits in a certain bit plane in the standard zig zag order and then encodes the (RUN, EOP) symbols with values as described above.

Since it is known exactly where the shifted-in zeros occur they can simply be ignored during the (RUN, EOP) encoding. The location of the shifted-in zeros is known from the frequency weighting matrix, which causes the shifting-in. In other words, the shifted-in zeros are simply not counted in the runs of zeros represented in the RUN value. The decoder also knows the positions of these zeros (from the weighting matrix), which are now not encoded, and correctly compensates for this during its DCT coefficient reconstruction.

FIG. 1 shows schematically the method including DCT transform 10, frequency weighting 12, (RUN, EOP) coding (without zeros) 14, followed by transmission 16. To decode the steps are reversed by inserting zeros into the DCT coefficient matrix at the positions known from the weighting matrix, (RUN, EOP) decoding, inverse frequency weighting, inverse selective enhancement weighting (if used), and then transforming back from the frequency (DCT) domain to a spatial domain.

As mentioned in the introduction, MPEG-4-FGS codes a differential image. It is an optional step to produce the differential signal after the DCT transform 10, instead of transforming a differential image. Thus, image information would be transformed followed by production of a difference signal from the transform coefficients.

FIG. 2 shows coding apparatus 18 having coding means 20 and viewing means 21 and shows decoding apparatus 22 having decoding means 24 and viewing means 26. The coding apparatus 18 may send a coded signal by transmission means 23 to the decoding apparatus 22 for decoding. Transmission apparatus (not shown) may incorporate the coding apparatus 18. An image reproduction device (not shown) may incorporate the decoding apparatus 22.

It would be advantageous for the VLC used by the (RUN, EOP) method to be re-optimised on application of the method proposed herein, but this is only optional. In VLC a codeword of variable length is assigned to each (RUN, EOP) pair, assigning shorter codewords to the more frequently occurring combinations. In FGS, the well-known Huffman codes are used for the variable length codes. These VLCs/Huffman codes are designed based on the frequency of occurrence of the various (RUN, EOP) combinations. As the (RUN, EOP) occurrences could change by not counting the shifted-in zeroes in the runs, the performance (compression ratio) could potentially be improved by redesigning these codes using the occurrence frequencies obtained for the modified (RUN, EOP) method.

The method described herein can be applied to increase the compression efficiency of an MPEG4-FGS enhancement layer over the usual application of that standard. In particular the method is beneficial at high quality when no or few bits are cut off from the enhancement layer bit stream.

Thus, the method disclosed herein provides more efficient coding to allow more information to be transmitted for a given bit rate, or at a given bit rate allows less time for transmission of a particular set of images.

Implementing the present invention in the (RUN, EOP) method is not a straight forward or obvious task to undertake because of the difficulty in amending the standard (RUN, EOP) scheme to discount the shifted-in zeros. A decision to implement the method from the outset must be made, because the bits are treated in runs (e.g. groups) in (RUN, EOP) rather than separately. In other coding systems separate treatment of the bits may make the implementation of the method more straight forward, particularly if the shifted-in bits are simply at the end of the data relating to one coefficient, making the procedure of not transmitting those bits trivial.

The method disclosed herein can be implemented in any product or system using the MPEG4-FGS bit plane compression method given suitable modifications. Devices such as consumer electronic devices including viewing means for displaying the images, semiconductor devices and similar components can all use the method disclosed herein.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of coding images in a scalable bit stream comprises transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

2. A method as claimed in claim 1, in which only those bit values of the binary representation up to, but not including, zero bit values introduced as a result of weighting are coded.

3. A method as claimed in claim 1, in which the weighting is a frequency, and/or a selective enhancement.

4. A method as claimed in claim 1, which is a modified version of the MPEG4-FGS method.

5. A method as claimed in claim 1, in which variable length coding for the RUN, EOP coding is re-optimised to account for encoding of the zero bits.

6. A method as claimed in claim 1, in which the coefficients are discrete cosine transform coefficients.

7. A method as claimed in claim 6, in which a pixel block is formed from a differential image

8. A method of decoding an image coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded, the method comprising reintroducing zeros resulting from the weighting into the coded RUN, EOP coefficients; RUN, EOP decoding; inverse weighting the coefficients; and transforming back from a frequency domain.

9. Coding apparatus (18) comprising coding means (20) operable to code images by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

10. Transmission apparatus comprising coding apparatus (18) as claimed in claim 9.

11. Decoding apparatus (22) comprises decoding means (24) operable to decode images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded, or operable to decode images by reintroducing zeros resulting from the weighting into the coded RUN, EOP coefficients; RUN, EOP decoding; inverse weighting the coefficients; and transforming back from a frequency domain.

12. An image reproduction device comprising decoding apparatus (22) as claimed in claim 11.

13. A signal comprising images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.

14. A storage medium having stored thereon a signal comprising images coded by transforming an image or differential image to give transform coefficients, weighting the coefficients in the scalable bit stream, and coding the coefficients according to a RUN, EOP scheme, wherein zero bit values of a binary representation of the coefficients introduced as a result of the weighting are not encoded.
